(19) United States
(12) Patent Application Publication
(10) Pub. No.: US 2018/0151160 A1
(43) Pub. Date: May 31, 2018

(54) Music Case Apparatus and Systems for Packing and Transportation

(71) Applicant: Jennifer Anderson, Paoli, PA (US)

(72) Inventor: Jennifer Anderson, Paoli, PA (US)

(21) Appl. No.: 14/960,363

(22) Filed: Dec. 5, 2015

(51) Int. Cl. G10G 7/00; A45C 11/00; A45C 7/00

(52) U.S. Cl. CPC G10G 7/005; A45C 11/00; A45C 2011/003; A45C 2011/002; A45C 7/0045

(57) ABSTRACT

Music instrument case apparatus and methods are taught for providing packing and transportation through an external pack, mating with a mounting area on a music instrument case. A set of fastening means in the mounting area provide for mating between the external pack and the music instrument case.

### BACKGROUND OF THE INVENTION

Many varieties and types of musical instrument soft cases are known. They may be specialized in certain areas, for example, cases that comprise, in part, a music stand or provide a strap system for ease of carrying. Internal packing capabilities of various cases have been explored in the art as well as electronic technology utilized in various ways in combination with cases.

What has been lacking to date, however, are improvements to the external side of musical instrument soft cases, and specifically improvements to the external side in packing and transportation have been lacking in the art.

### SUMMARY OF THE INVENTION

The present invention, in various embodiments, comprise improvements to the external side of a musical instrument case for providing packing and transportation utility.

A soft musical instrument case is provided with a set of fastening means in a mounting area for mating with fastening means in a mounting area on an external pack. The external pack may be used between different musical instrument cases, as may be carrying means. Numerous external packs may be used and cases may be provided with more than one mounting area and fastening means within those areas.

### BRIEF DESCRIPTION OF THE DRAWINGS

FIG. 1 shows an embodiment.

FIG. 2 shows an embodiment.

FIG. 3 shows an embodiment.

FIG. 4 shows an embodiment.

FIG. 5 shows an embodiment.

### DETAILED DESCRIPTION OF THE EMBODIMENTS

Various embodiments may provide soft cases for various instruments, e.g., guitars (including various sizes for both acoustic, electric and bass guitars,) mandolins, ukuleles, banjos, and other stringed and musical instruments.

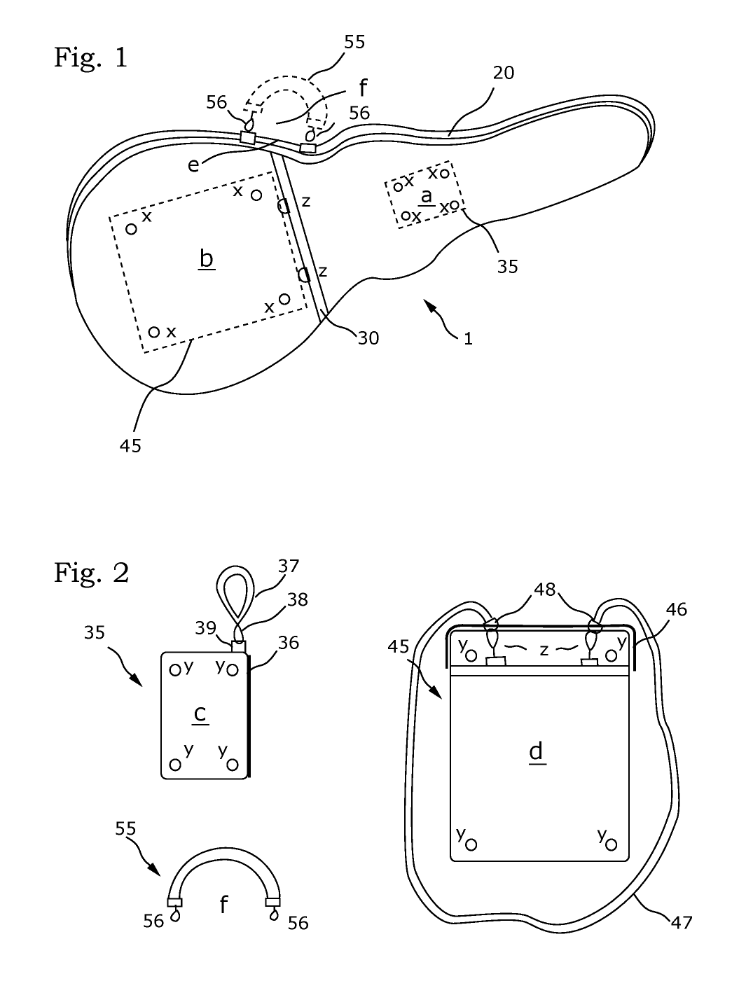

FIG. 1 shows soft case 1—here for a guitar—comprised of materials such as fabric, including canvas, nylon, and other suitable materials. Case materials may be provided with various features as well, e.g., water repellency, waterproof, etc. Various embodiments may feature various padding materials to protect the instrument, such as foam, fabric and/or other soft and/or plush materials. Handle 55 is for carrying the case, although embodiments may feature other modes for transportation as well (e.g., backpack straps, shoulder straps, etc.) Zipper 20 is for closing the case although other closure means (e.g., Velcro® or Velcro® type fasteners, clips, hooks, buckles etc.) may be used as well.

A first set of fastening means is provided in each of mounting areas a and b. In this embodiment, that first set comprises snap fasteners x in mounting areas a and b, which are provided in a mating pattern, that is, a pattern complementary to first sets of fastening means provided on mounting areas on various external pack embodiments, as is further described below. (Throughout mating and complementary are meant to be understood as used interchangeably.) Generally, fastening means in this and other embodiments are of a removable type, such as snaps (a term meant to include snap fasteners, rivets, etc.,) snap hooks, D-rings, Velcro® or other similar hook type fastener, buckles, clips, and other types of detachable fasteners known in the art.

A second set of fastening means is provided in mounting area b. In this and other embodiments an additional set or sets of fastening means may be located in mounting areas, which themselves may be of various numbers and/or placements. Here a set of D-rings z provides a second set of fastening means. Fastening means here include the D-rings shown and may also be snaps (snap fasteners, snap rivets, etc.,) snap hooks, Velcro® or other similar hook type fastener, buckles, clips, and other types of detachable fasteners known in the art. It should be noted that the use of the term “set of fasteners” is meant to include embodiments where a set may be a single fastener.

Returning to the embodiment of FIG. 1, soft case 1 is provided with a mounting area e. Handle 55 is detachably mounted in mounting area e, through a set of snap hooks 56 comprising a set of fastening means depending from handle 55 in a mounting area f of handle 55 in mating engagement with complementary set of fastening means D-rings (not shown) provided in mounting area e. Other types of complementary fastening means may be used as well, including snaps (snap fasteners, snap rivets, etc.,) snap hooks, Velcro® or other similar hook type fastener, buckles, clips, and other types of detachable fasteners known in the art.) Other embodiments may provide carrying means instead of a handle such as straps (for example, backpack straps, shoulder straps, etc.) with a mounting area or areas, with a set or sets of fastening means in that area or areas, to complementary set or sets fastening means on a mounting area or areas on a case embodiment.

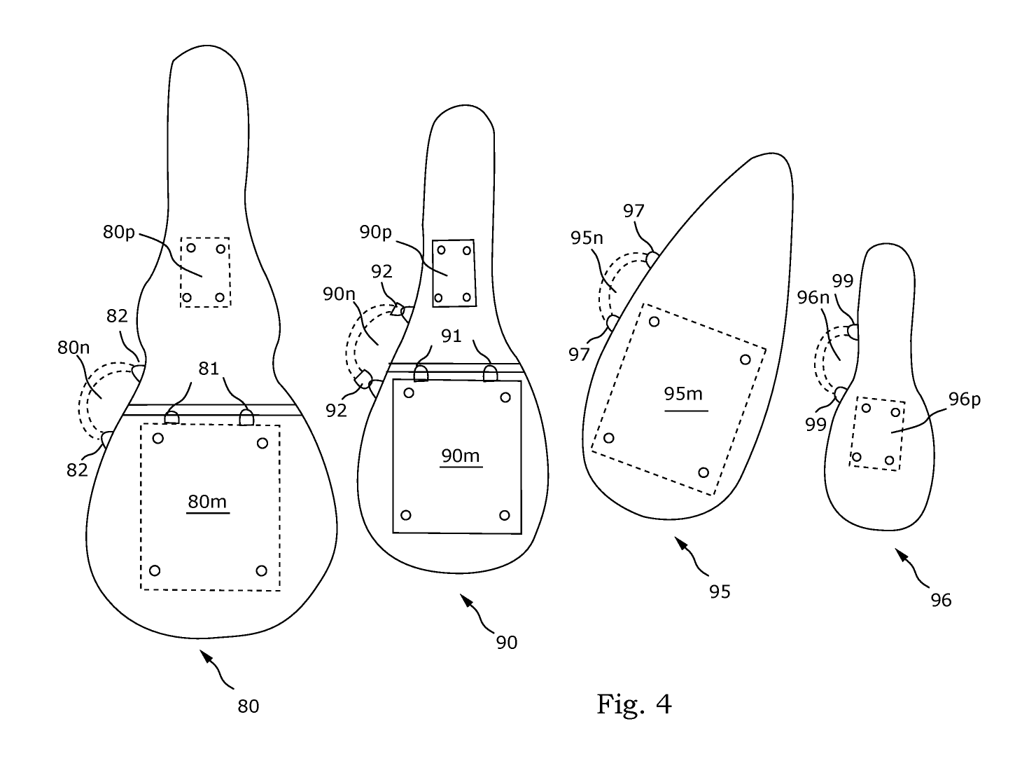

FIG. 2 shows attachment sides of the external packs 35 and 45 as provided in various embodiments, for mounting to various external areas of a musical instrument soft case embodiment. Here the embodiments are provided for mounting areas a and b of soft case 1, and may be used as well in other case embodiments that are provided with mating mounting areas to those of the embodiments, as is further described herein. Those mating areas may be one or more (so for example, the soft case 1 of FIG. 1 has two. Other embodiments may provide one mounting area, more than two, etc. see, e.g., FIG. 4.)

First sets of fastening means, here snaps y in mating configuration with snaps x of FIG. 1, are provided in mounting areas c and d of packs 35 and 45 respectively. A second set of fastening means, snap hooks z, are also provided in mounting area d of pack 45. As described further herein, in this and other embodiments, the sets of fastening means provided on packs are complementary to sets of fastening means provided on music instrument soft case embodiments so that packs may be removed and mounted on various instrument cases.

It should also be noted that external packs may also feature another set or sets of fastening means providing various uses. For example, a set may be used for “piggybacking” other packs, with a mating mounting area or areas to those on another pack. Embodiments may also provide a set of fastening means for carrying means. So for example snap hooks z may be used as well to mate with complementary fastening means 48 on strap 47 on pack 45. Another example is fastening means 38 mating with complementary D-ring 39 for strap handle 37 on pack 35.

It should be noted that packs may be provided in various shapes and sizes. So external packs may be provided to hold a phone, tablet, notebook computer, book, notebook, folder, binder, containers for food, drink, storage, and/or musical accessories. Additionally, external packs may be comprised of the same material as the case, as well as other materials. While embodiments may provide for enclosed packs, other embodiments may provide for an open type unenclosed pack e.g., water bottle holder, envelope type, folder type, etc. as well.

Returning to FIG. 2, pack 35 is dimensioned to fit in the narrower neck mounting area a of soft case 1 of FIG. 1. Pack 45 is provided with dimensions appropriate to mounting area b of soft case 1 of FIG. 1. It should be noted however that packs may be used in any mating mounting area on a case as desired. Zippers 36 and 46 are used to close packs 35 and 45 respectively. Other closure means, (e.g., Velcro® or other similar hook type fastener, etc.) may be used.

Carrying handle 55 with mounting area f is configured to mate with mounting area e of the embodiment of FIG. 1 by providing complementary sets of fastening means 56 on handle 55 with those of case 1. As with external pack embodiments, mounting areas on handles or other carrying embodiments (e.g. straps etc.) are provided in mating configurations with mounting areas on the case. So for example, handle 55 may also be used with other cases, with complementary mounting areas and fastening means.

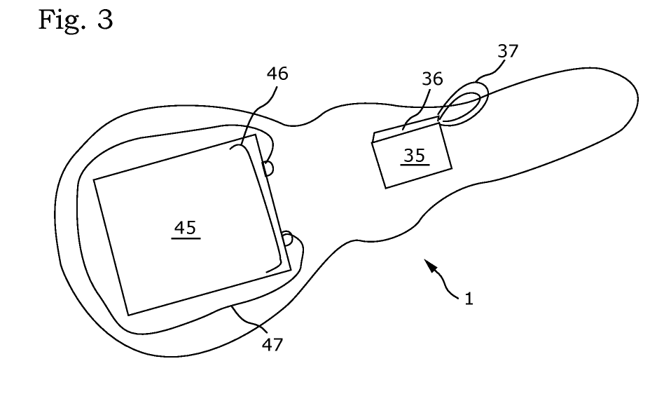

FIG. 3 shows external packs 35 and 45 mated with case 1. The packs may be removed, as the fastening means (not shown) are of a removable type as taught herein.

External pack 35 is shown with strap handle 37 for carrying when pack 35 is detached from case 1. Strap handle 37 is also detachable and storable in pack 35. External pack 45 is shown with strap 47 for carrying when pack 45 is detached from case 1. Strap 47 is also detachable and storable in pack 45.

FIG. 4 show various musical instrument case embodiments. Case 80 is for a full size guitar with mounting areas 80m and 80p, with first sets of fastening means (shown in phantom) in mounting areas 80m and 80p, as well as a second set of fastening means 81 D-rings in mounting area 80m. Mounting area 80n is for a carrying means (e.g., a handle, strap, etc.) with D-rings 82 comprising a first set of fastening means in mounting area 80nCase 90 is for a ¾ size or travel guitar with mounting areas 90m and 90p, as well as a second set of fastening means 91, and mounting area for 90n with fastening means 92 for carrying means. Case 95 is for a mandolin with mounting area 95m and mounting area 95n with fastening means 97 for carrying means. Case 96 is for a ukulele with mounting area 96p and mounting area 96n with fastening means 99 for carrying means.

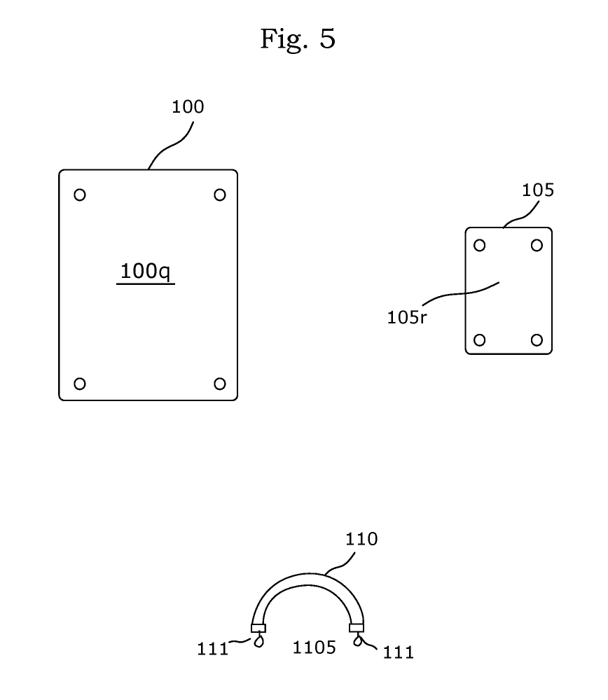

FIG. 5 shows external packs 100 and 105 with mounting areas 100q and 105r respectively. Mounting area 100q is for mounting to complementary mounting areas 80m, 90m or 95m of packs 80, 90 and 95 respectively of FIG. 4 through a first set of fastening means (shown in outline.) Here external pack 100 has only a first set of fastening means, so the second set of fastening means 81 and 91 on packs 80 and 90 of FIG. 4 would not be engaged. Pack 105 is also shown in FIG. 5, and it has a mounting area 105r for mating with mounting are 80p, 90p or 96p on packs 80, 90 and 96 respectively of FIG. 4, through a set of fastening means shown in outline. Handle 110 is also shown in FIG. 5, with mounting area 110s which is complementary to mounting areas 80n, 90n, 95n, and 96n on cases 80, 90, 95 and 96 respectively of FIG. 4. Fastening means 111 engage mating complementary fastening means in the identified mounting areas.

These and other advantages and features of the present invention are described herein with specificity so as to make the present invention understandable to one of ordinary skill in the art, both with respect to how to practice the present invention and how to make the present invention.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

I claim:

1. An apparatus for carrying a musical instrument comprising a soft case for an instrument further comprising a mounting area for an external pack, with said mounting area being configured, through a first set of fastening means, to mate with a first set of fastening means on a mounting area on an external pack.

2. An apparatus as in claim 1 further comprising a second set of fastening means located in said mounting area, to mate with a second set of fastening means on said mounting area on said external pack.

3. An apparatus as in claim 1 further comprising a second mounting area for a second external pack, with said second mounting area being configured, through a first set of fastening means, to mate with a first set of fastening means on a mounting area on said second external pack.

4. An apparatus as in claim 1 further comprising a mounting area for a carrying means, comprising a handle or strap, with said mounting area for a carrying means being configured, through a set of fastening means, to mate with a set of fastening means on a mounting area on said carrying means.

5. An apparatus as in claim 1 further comprising an external pack for mating with said soft case, said external pack further comprising a mounting area, with said mounting area being configured, through a first set of fastening means, to mate with the first set of fastening means on a mounting area on said soft case.

6. An apparatus as in claim 1 with said external pack further comprising a device or thing selected from the group consisting essentially of an enclosure for a phone, tablet, notebook computer, notebook, folder, binder, book, containers for food, drink, storage, and/or musical accessories.

7. An apparatus for carrying a musical instrument comprising a soft case for an instrument further comprising a mounting area for an external pack, with said mounting area being configured, through a first set of fastening means, to mate with a first set of fastening means on a mounting area on an external pack;
further comprising an external pack for mating with said soft case, said external pack further comprising a mounting area, with said mounting area being configured, through a first set of fastening means, to mate with the first set of fastening means on a mounting area on said soft case.

8. An apparatus as in claim 7 with said external pack further comprising a device or thing selected from the group consisting essentially of an enclosure for a phone, tablet, notebook computer, notebook, folder, binder, book, containers for food, drink, storage, and/or musical accessories.

9. An apparatus as in claim 7 wherein said cases further comprises a second mounting area for a second external pack, with said second mounting area being configured, through a first set of fastening means, to mate with a first set of fastening means on a mounting area on said second external pack;
further comprising a second external pack for mating with said soft case, said second external pack further comprising a mounting area, with said mounting area being configured, through a first set of fastening means, to mate with the first set of fastening means on said second mounting area on said soft case.

10. A system for music instrument soft case packing and transportation, comprising:
a first soft case for an instrument further comprising a mounting area for an external pack, with said mounting area being configured, through a first set of fastening means, to mate with a first set of fastening means on a mounting area on an external pack;
a second soft case for an instrument further comprising a mounting area for said external pack, with said mounting area being configured, through a first set of fastening means, to mate with said first set of fastening means on said mounting area on said external pack,
wherein said external pack is for mating with said first or second soft case, with said mounting area of said external pack having said first set of fastening means configured to mate with said first set of fastening means on said mounting area on said first or second soft case.

11. A system as in claim 10 wherein said external pack further comprises an enclosure for a device or thing selected from the group consisting essentially of a phone, tablet, notebook computer, book, notebook, folder, binder, containers for food, drink, storage, and/or musical accessories.

12. A system as in claim 10 further comprising a second set of fastening means located in said mounting area of said first case, to mate with a second set of fastening means on said mounting area on said external pack.

13. A system as in claim 10 further comprising a second mounting area for a second external pack, with said second mounting area being configured, through a first set of fastening means, to mate with a first set of fastening means on a mounting area on said second external pack.

14. An apparatus as in claim 10 further comprising a mounting area for a carrying means, comprising a handle or strap, with said mounting area for a carrying means being configured, through a set of fastening means, to mate with a set of fastening means on a mounting area on said carrying means.
